(19) United States
(12) Patent Application Publication
(10) Pub. No.: US 2023/0358101 A1
(43) Pub. Date: Nov. 9, 2023

(54) DIGGING APPARATUS WITH SAFETY MECHANISM

(71) Applicant: Techtronic Cordless GP, Anderson, SC (US)

(72) Inventors: Koon For Chung, Kwai Chung (CN); Hui Jian Chen, Dongguan City (CN); Xiao Di Lan, Dongguan City (CN); Yan Jia Wang, Dongguan City (CN); Jonathan Robert Feldkamp, Anderson, SC (US); Shuai Shao, Simpsonville, SC (US); Grzegorz Kondro, Piedmont, SC (US); Richard Michael Mcentyre, Anderson, SC (US); Gregory Scott Torrisi, Anderson, SC (US); John Eugene McCallum, Anderson, SC (US)

(21) Appl. No.: 17/777,424

(22) PCT Filed: Oct. 15, 2020
(86) PCT No.: PCT/CN2020/121154

§ 371 Date: May 17, 2022

(30) Foreign Application Priority Data
Nov. 18, 2019 (HK) 19132358.3

(51) Int. Cl. E21B 11/00; E21B 10/44; B28D 1/14

(52) U.S. Cl. CPC E21B 10/44; B28D 1/14; E21B 11/005; B23B 2226/75; B23B 2260/096; B23B 2260/122; B23B 2260/128

(57) ABSTRACT

Provided herein is an electric powered digging apparatus comprising: a powerhead, the power head comprises a motor and a gearbox; a handle frame, the powerhead is mounted onto the handle frame; and a drill bit, the drill bit is driven by the motor to rotate around a longitudinal axis, the electric power digging apparatus further comprises: a first safety mechanism, wherein the first safety mechanism reduces torque output to the drill bit when the powerhead spins around the longitudinal axis for an angle larger than a first threshold, and a second safety mechanism, wherein the second safety mechanism reduces torque output to the drill bit when the powerhead spins around the longitudinal drive axis at an angular speed larger than a second threshold FIG. 1

### FIELD OF THE INVENTION

The present disclosure generally relates to a hand-operated digging apparatus, and particularly relates to an electric powered ground auger suitable, but not exclusively, for digging into the substrate with safety mechanism.

### BACKGROUND OF THE INVENTION

Hand-operated digging apparatus, such as ground augers, are widely used to penetrate the ground and dig holes in the earth. A typical electric powered digging apparatus often includes a powerhead and a rotatable drill bit with a helical auger blade coaxially mounted around the drill bit. An electric powered motor in the powerhead drives the drill bit and rotates the helical auger blade downwardly into the soil.

Generally, hand-operated digging apparatuses are designed to be used with a broad range of soil or sand types having diverse physical properties and compositions. When operating a hand-operated digging apparatus in difficult ground conditions, or drilling through stones or hard rocks, such as granite or limestone, the helical auger blade may not advance downwardly and a kickback may occur, resulting in an opposite torque exerted on the operator of the digging apparatus. If the operator is not gripping the handles of the digging apparatus with sufficient force, the hand-operated digging apparatus may dangerously and uncontrollably self-rotate, which may cause injury to the operator. A typical digging apparatus may not be equipped with safety mechanisms for preventing kickback of the digging apparatus.

In addition, the maximum torque of a hand-operated digging apparatus is generally predefined by the manufacturer and the degree of customization for each individual operator may be not possible. In real world applications, it can be inefficient or even dangerous to use the same maximum driving power for all operators, without taking into account the operator’s physical strength. If the operator is not physically strong enough and is not able to safely control a hand-operated digging apparatus with high torque, kickback may occur more frequently and the operator may be presented with a higher chance of personal injury.

In view of at least the foregoing deficiencies of conventional electric powered hand-operated digging apparatus, there is a need in the art for an improved digging apparatus that has a stopping or a braking mechanism for minimizing the chance of accidents and/or abnormal operation.

### SUMMARY OF THE INVENTION

Provided herein is An electric powered digging apparatus, comprising: a powerhead, the power head comprises a motor and a gearbox; a handle frame, the powerhead is mounted onto the handle frame; and a drill bit, the drill bit is driven by the motor to rotate around a longitudinal axis, the electric power digging apparatus further comprises: a first safety mechanism, wherein the first safety mechanism reduces torque output to the drill bit when the powerhead spins around the longitudinal axis for an angle larger than a first threshold, and a second safety mechanism, wherein the second safety mechanism reduces torque output to the drill bit when the powerhead spins around the longitudinal drive axis at an angular speed larger than a second threshold.

According to certain aspects, the first safety mechanism comprises a braking lever extending out from the handle frame, the braking level is pivotable relative to the handle frame from a starting position to an end position, an angle between the starting position and the end position of the braking lever is larger than or equal to the first threshold.

According to certain aspects, the end position comprises a first end position corresponding to a first value of the first threshold, and a second end position corresponding to a second value of the first threshold.

According to certain aspects, the first safety mechanism further comprises a sensor for sensing the pivoting angle of the braking lever.

According to certain aspects, the first safety mechanism further comprises a switch to be actuated by the braking lever as it pivots from the starting position to the end position.

According to certain aspects, the first safety mechanism further comprises a biasing member for returning the braking lever from the end position to the starting position.

According to certain aspects, the starting position of the braking lever is adjustable.

According to certain aspects, the second safety mechanism comprises a rotation sensor coupled to the power head or the handle frame, the rotation sensor is configured to measure the angular speed of the power head or the handle frame.

According to certain aspects, the rotation sensor is a gyroscopic sensor.

According to certain aspects, the electric power to the motor is cut off when at least one of the first safety mechanism and the second safety mechanism is actuated.

According to certain aspects, the electric power to the motor is reduced so that the motor output toque is reduced when at least one of the first safety mechanism and the second safety mechanism is actuated.

According to certain aspects, the motor rotation is reversed for a predetermined period of time when at least one of the first safety mechanism and the second safety mechanism is actuated.

According to certain aspects, the powerhead further comprises a clutch, the clutch is actuated to lock the motor and/or gearbox when at least one of the first safety mechanism and the second safety mechanism is actuated.

According to certain aspects, the digging apparatus further comprises a current sensor, electric power to the motor is cut off when the current sensor measures an electric current to the motor larger than a third threshold.

According to certain aspects, the digging apparatus further comprises a control module, the control module is configured to input, store and apply user-specific operation profile, wherein each user-specific operation profile allows a respective user to specify at least one of the first threshold and the second threshold.

According to certain aspects, the control module is configured for the user to input a respective operation profile with a learning mode, at least one of the first threshold and the second threshold is determined when a specified event occurs as a motor output torque is increased from zero.

According to certain aspects, the specified event is selected from one of the following: a user releases a trigger, a user presses a trigger, the powerhead spins for a predetermined angle, the powerhead spins above a predetermined angular speed, and the powerhead spins above a predetermined angular acceleration speed.

According to certain aspects, the digging apparatus further comprises a threshold selector for an operator to select from multiple values for the first threshold and/or the second threshold.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Other aspects and advantages of the present invention are disclosed as illustrated by the embodiments hereinafter.

### BRIEF DESCRIPTION OF THE DRAWINGS

The appended drawings contain figures to further illustrate and clarify the above and other aspects, advantages and features of the present disclosure. It will be appreciated that these drawings depict only certain embodiments of the present disclosure and are not intended to limit its scope. It will also be appreciated that these drawings are illustrated for simplicity and clarity and have not necessarily been depicted to scale. The present disclosure will now be described and explained with additional specificity and detail through the use of the accompanying drawings in which:

FIG. 1 is a perspective view of an electric powered digging apparatus with safety mechanism in accordance with certain embodiments of the present disclosure;

FIG. 2 is a perspective view of another electric powered digging apparatus with safety mechanism in accordance with certain embodiments of the present disclosure;

FIG. 3 is a perspective view of a housing of the powered digging apparatus with safety mechanism in accordance with certain embodiments of the present disclosure;

FIG. 4 is a perspective view of the motor and the gearbox in accordance with certain embodiments of the present disclosure;

FIG. 5 is an exploded view of the motor of FIG. 4 in accordance with certain embodiments of the present disclosure;

FIG. 6 is an exploded view of the gearbox of FIG. 4 in accordance with certain embodiments of the present disclosure;

FIG. 7 is a front view of a drill bit of the digging apparatus of FIGS. 1 or 2 in accordance with certain embodiments of the present disclosure;

FIG. 8 is an exploded view of the braking lever and hinge of the digging apparatus of FIGS. 1 or 2 in accordance with certain embodiments of the present disclosure;

FIG. 9 is a schematic electrical connection diagram of the digging apparatus of FIGS. 1 or 2 in accordance with certain embodiments of the present disclosure;

FIG. 10A is a current profile of the digging apparatus of FIGS. 1 or 2 with increasing electric current from the battery in accordance with certain embodiments of the present disclosure; and

FIG. 10B is a graph showing the electric current measurement when the digging apparatus of FIGS. 1 or 2 hits stones and the motor is cut off.

### DETAILED DESCRIPTION OF THE INVENTION

The present disclosure generally relates to an electric powered hand-operated digging apparatus for digging into the substrate. More specifically, but without limitation, the present disclosure relates to a hand-operated digging apparatus, such as a ground auger, for digging into the substrate with safety mechanism. It is an objective of the present disclosure to provide a digging apparatus having a stopping or a braking mechanism that can be customized for each operator and/or for preventing abnormal operation (e.g., kickback).

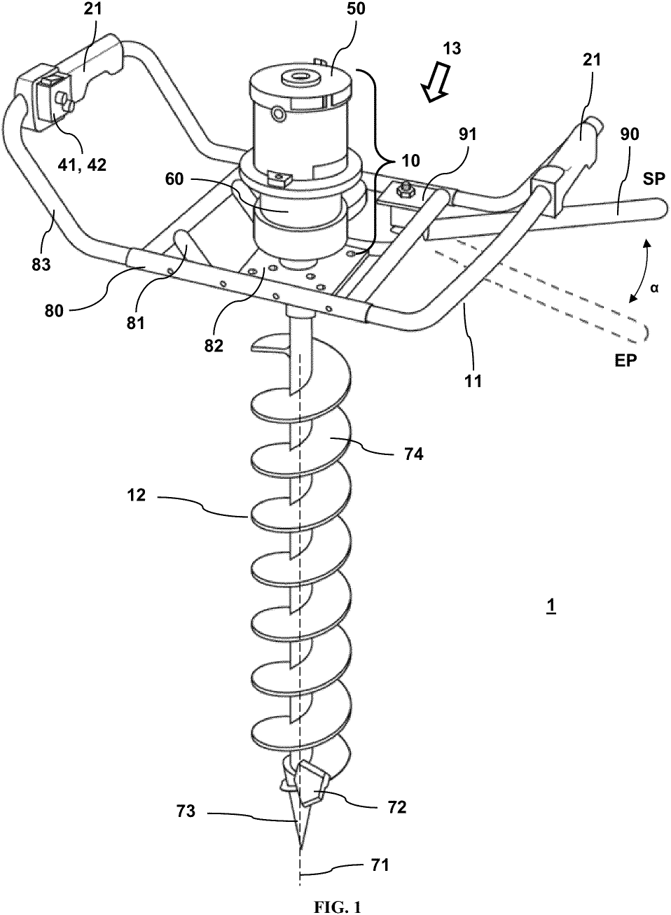

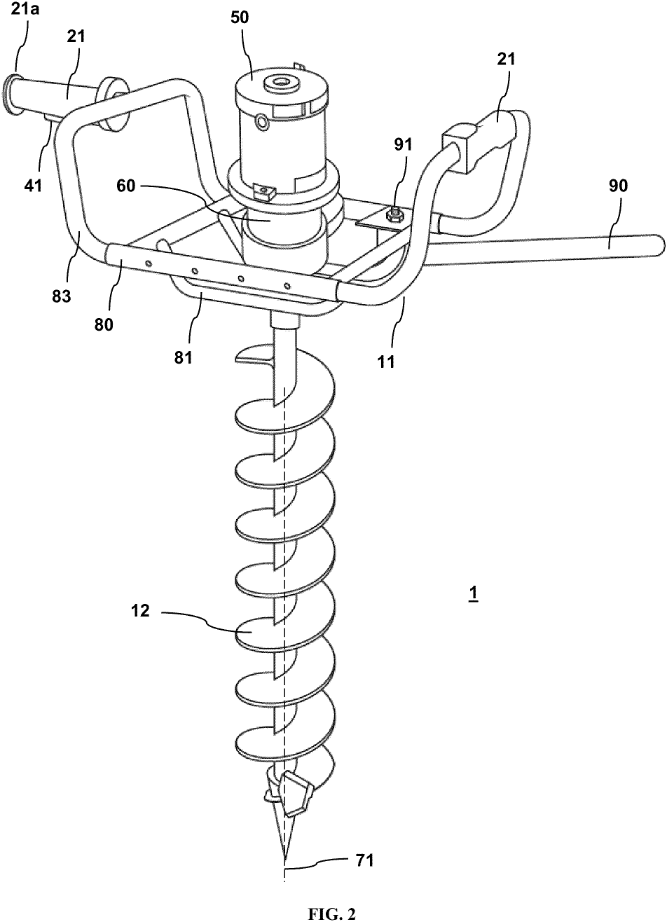

FIGS. 1-2 show perspective views of a digging apparatus 1 in accordance with certain embodiments of the present disclosure. The digging apparatus 1 comprises a powerhead 10, a handle frame 11 and a drill bit 12. For the sake of clarity, a housing of the powerhead 10 is not shown. The digging apparatus 1 may be a hand-operated auger that can be used for a variety of applications, and in particular, for drilling small-dimension deep holes into substrate. The substrate may be soil, sand, wall, wood, concrete, ice, etc. For instance, the drilled hole can be used for planting a tree, piling a post, or constructing a building foundation. In the case of ice drilling, the drilled hole can be used for ice fishing and under-ice exploration. An operator usually places the digging apparatus 1 vertically above the desired position of the hole to be drilled so that the drill bit 12 can drill vertically downward into the substrate.

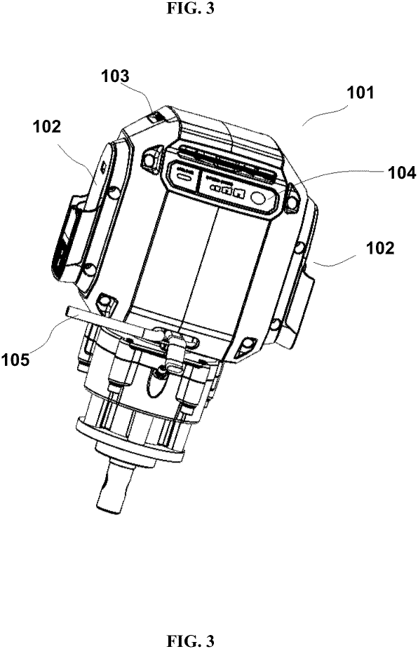

The powerhead 10 may include a motor 50 and a gearbox 60. A housing 101 of the powerhead 10 according to certain embodiments of the present disclosure is shown in FIG. 3. The housing 101 comprises one or more battery interfaces 102 for receiving one or more batteries. The battery may be a 36V lithium battery pack or two 18V lithium battery packs. In certain embodiments, two battery interfaces 102 are provided at the two sides of the housing 101. In other embodiments, one battery interface is provided at the rear of the housing 101. The housing 101 further comprises one or more venting holes 103 so air can be drawn into and driven out of the housing 101 for cooling of the motor 50 and the gearbox 60. In certain embodiments, the venting holes 103 may be provided at the top and/or bottom of the housing 101. The housing 101 may also provide a user interface 104 for an operator to control and/or configure the digging apparatus 1. The user interface 104 may comprise one or more of indicator, display, mechanical button, membrane button, and touch screen. The housing 101 may also have an electrical interface 105 for electrical communication with one or more sensors disposed outside the housing.

The handle frame 11 of the digging apparatus 1 may include a bottom frame 80 and two side frames 83. One or more handle grips 21 are mounted to or from the handle frame 11. In certain embodiments, the bottom frame 80 defines a sunk area, such that the powerhead 10 is at least partially surrounded by the bottom frame 80 for better protection. The powerhead 11 may be attached to and detached from the bottom frame 80 through a mounting plate 82 for easy transportation. In certain embodiments such attachment and detachment are achieved without using of tools. A soft protective material may be wrapped around the tubular steel of the bottom frame 80 and/or the side frames 83 to reduce the transmission of vibration from the digging apparatus 1 to the operator when operating the digging apparatus 1. The mounting plate 82 is perpendicular to a longitudinal drive axis 71, which extends generally vertical from the motor 50 to a distal end 73 of the drill bit 12.

Two side frames 83 are mounted to or otherwise fixed to the bottom frame 80. In certain embodiments as shown in FIG. 1, the two side frames 83 are symmetrical to each other and may each have a U-shape. The two side frames 83 may bend upwardly from the bottom frame 80. In such a configuration, the handle grips 21 can have a higher vertical position than the bottom frame 80. In other words, the bottom frame 80 can be at a level around an operator’s waist or thigh when the operator grips the two handle grips 21 and operate the digging apparatus 1. This is useful for the safety mechanism to work, which will be discussed later.

In certain embodiments, there are two handle grips 21 connected to opposing sides of the handle frame 11. The two handle grips 21 may be respectively provided at the middle part of the two side frames 83. The two handle grips 21 can be configured symmetrically as shown in FIG. 1 or asymmetrically as shown in FIG. 2. The handle grip 21 can surround a portion of the side frame 83 or extend out of the side frame 83 away from the motor 50 with a free end 21a pointing away from the motor 50. By configuring the handle grip 21 to extend out of the handle frame 11, the dimension of the handle frame 11 can be reduced, while the distance between two handle grips 21 can be maintained for an operator to apply sufficient torque without too much difficulty.

In certain embodiments, a control button 41 is provided on at least one of the handle grips 21, to be manually operable by the operator. The control button 41 may be switched between an “ON” position and an “OFF” position. When the control button 41 is in the “ON” position, the motor 50 of the digging apparatus 10 may be operated. When the control button 41 is in the “OFF” position, the motor 50 of the digging apparatus 10 is prevented from being operated.

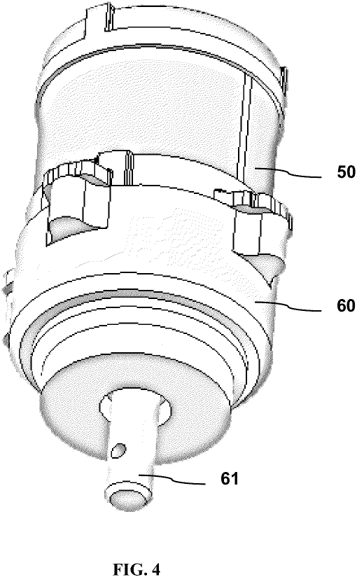

To assemble the powerhead 11 of the digging apparatus 1, the motor 50 and the gearbox 60 are mounted to each other and placed within the housing 101. The housing 101 is mounted on a mounting plate 82. The mounting plate 82 is welded or otherwise fixed to one or more support tubes 81. In certain embodiments, the support tubes 81 can have a V-shape, a U-shape, or any other desired shape. The support tubes 81 are welded or otherwise securely attached to the bottom frame 80 to form a protective frame component for the motor 50 and the gearbox 60, with an output shaft 61 extending downward outside the mounting plate 82. As shown in FIG. 4, the motor 50 is mounted on top of the gearbox 60 for driving the digging apparatus 1. In certain embodiments, the motor 50 may drive a clutch (not shown) placed within the case holding the gearbox 60, and the clutch further drives the gearbox 60. The clutch can be a mechanical clutch or an electronic clutch. The gearbox 60 has an output shaft 61 for driving the drill bit 12. The gearbox 60 is configured to be driven by the motor 50 with a gear reduction ratio.

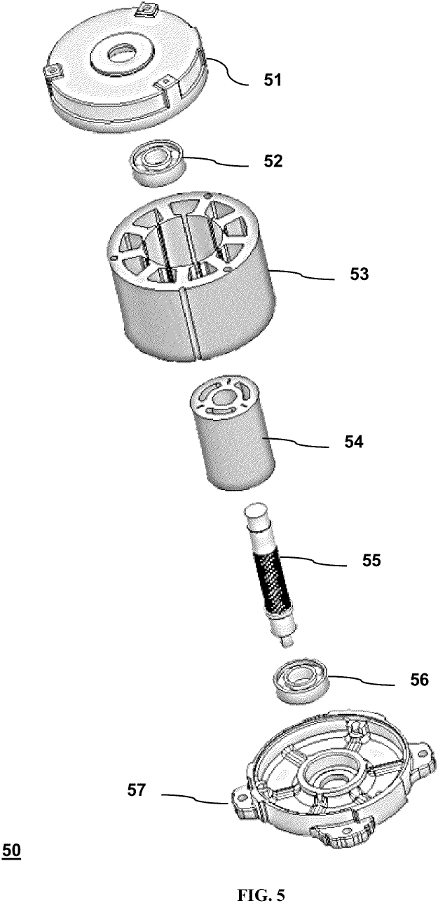

As shown in more detail in FIG. 5, in certain embodiments the motor 50 of the powerhead 11 of the digging apparatus 1 comprises an upper housing 51, a first motor bearing 52, a stator 53, a rotor 54, a rotor shaft 55, a second motor bearing 56, and a lower housing 57.

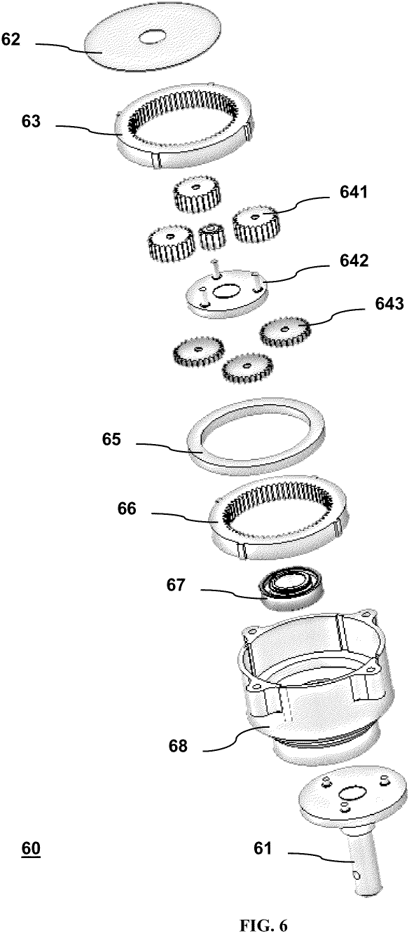

As shown in more detail in FIG. 6, in certain embodiments the gearbox 60 of the powerhead 11 of the digging apparatus 1 comprises a washer 62, a first ring gear 63, a first layer planetary gear 641, a first layer planet carrier 642, a second layer planetary gear 643, a retaining ring 65, a second ring gear 66, a gearbox bearing 67, a gearbox housing 68, and an output shaft 61.

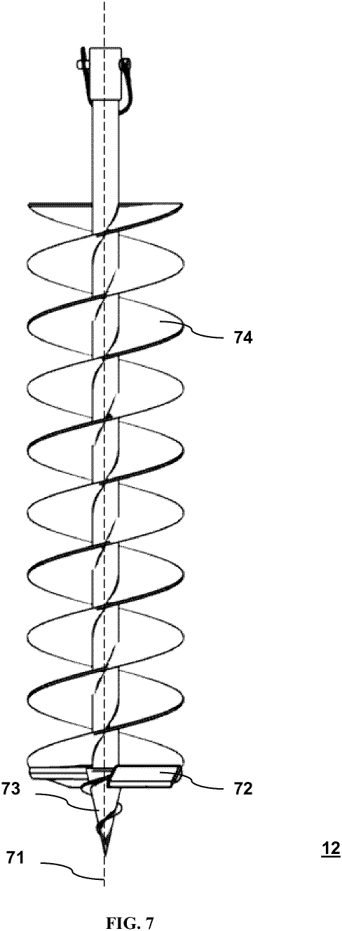

In certain embodiments, the drill bit 12 is operatively associated with and driven by the motor 50 via the gearbox 60. Now referring to FIG. 7, the drill bit 12 is releasably connected to the powerhead 11 and is concentric and coaxial with the output shaft 61. The output shaft 61 is at the bottom of the powerhead 11. The drill bit 12 and the output shaft 61 share the same longitudinal drive axis 71. The longitudinal drive axis 71 is the axis about which rotation of the drill bit 12 occurs. The drill bit 12 extends vertically along and rotates around the longitudinal drive axis 71 to a distal end 73 and makes contact with the ground or the substrate to be dug. In certain embodiments, the drill bit 12 comprises one or more flight teeth 72 at the distal end 73 of the drill bit 12, and a helical auger blade 74 coaxially mounted around the drill bit 12 and spirally screwed towards the distal end 73 of the drill bit 12. When in use, e.g. when the drill bit 12 of the digging apparatus 1 abuts or penetrates a substrate to be dug, as the longitudinal drive axis 71 extends generally vertically, the direction of movement of the handle grips 21 (and the powerhead 11) is generally downward. Upon movement of the handle grips 21 in this direction and the activation of the control button 41, the powerhead 11 is configured to enable electric power supplied from the battery to the motor 50. As such, the motor 50 drives the output shaft 61 to rotate in a clockwise direction (when seen from FIG. 1) and causes the drill bit 12 to rotate in the same direction. The drill bit 12 can dig and move downward into the substrate, thus also move the digging apparatus 1 downward into the substrate.

The digging apparatus 1 of the present disclosure comprises at least a first safety mechanism and a second safety mechanism for anti-kickback purpose. When kickback happens and the motor 50 keeps working, the drill bit 12 is stalled and the powerhead 11 and the handle frame 12 start spinning in an opposite direction. This is particularly dangerous to the operator as the operator’s hands still hold the handle frame 12. It is therefore essential that the spinning be minimized to protect the operator. In essence, the first safety mechanism and a second safety mechanism work under different principles to reduce or cut off power output in case of kickback, either immediately or after a predetermined period of time. The waiting for a predetermined period of time helps to prevent false alarms due to, e.g. sensor error or operator gaining back control.

In certain embodiments, when the first and/or second safety mechanism is actuated, power supply to the motor is cut off either immediately or after a predetermined period of time. In certain embodiments, when the first and/or second safety mechanism is actuated, the power supply to the motor is not cut off but reduced. As a result, the motor output torque is reduced. This may help the operator to gain back control and hold the digging apparatus steady as the operator’s output torque may surpass the motor output torque. In this way, the digging operation is not interrupted. Under such configuration, there may be provided at least one further determination whether the operator is able to gain back control or the kickback stops. If not, the first and/or second safety mechanism can be actuated again to further reduce or cut off power supply to the motor. In certain embodiments, rather than passively preventing kickback, active measures can be taken when the first and/or second safety mechanism is actuated. For instance, the clutch with the gearbox can lock the motor or the gearbox in case of kickback. In other embodiments, the motor rotation can be reversed for a predetermined period of time.

In certain embodiments, the first safety mechanism is actuated when the powerhead spins an angle over a first threshold. The first threshold can be a fixed one, or adjustable according to different operators. In certain embodiments, the first threshold can be an angle between 10 degrees and 60 degrees, between 15 degrees and 45 degrees, or between 20 degrees and 30 degrees. The first safety mechanism can be actuated more than once during the operation of the digging apparatus. In other words, there can be more than one first threshold.

Refer back to FIG. 1, the first safety mechanism comprises a braking lever 90 that is coupled to the bottom frame 80 or another portion of the handle frame 11 and extends therefrom. The braking lever 90 extends in a plane generally perpendicular to the longitudinal drive axis 71. In certain embodiments, this plane is substantially at the same level as the bottom frame 80, or at a level that is around the operator’s waist or thigh level. The level of the braking lever 90 may be adjustable to accommodate to operators of different heights.

The braking lever 90 can spin together with the handle frame 11, but as it hits some obstacle (e.g. operator’s waist or thigh), the braking lever 90 can pivot relative to the handle frame 11. As the braking lever 90 pivots, it pivots between a starting position SP and an end position EP, defining an angle α therebetween. This angle α can be the same as or larger than the first threshold. The first safety mechanism can be actuated when or before the braking lever 90 pivots the angle α to the end position EP. In certain embodiments, the braking lever 90 can continue pivoting past the end position EP. This is mainly meant to avoid hurting the operator in case the spinning of powerhead 10 is not timely stopped.

In other embodiments, the braking lever 90 can pivot from the starting position SP to a first end position EP1 and a second end position EP2. As the braking lever 90 pivots to the first end position EP1, the first safety mechanism can be actuated, and a first safety measure can be activated. If the braking lever 90 continues to pivot to the second end position EP2, the first safety mechanism can be actuated again, and a second safety measure can be activated. In certain embodiments, the first safety measure can be reducing power supply to the motor and the second safety measure can be cutting off power supply to the motor. In certain embodiments, the first safety measure can be cutting off power supply to the motor and the second safety measure can be reversing rotation of the motor for a predetermined period of time. Other combinations of first safety measure and second safety measure are also possible. Also, there can be more than two end positions.

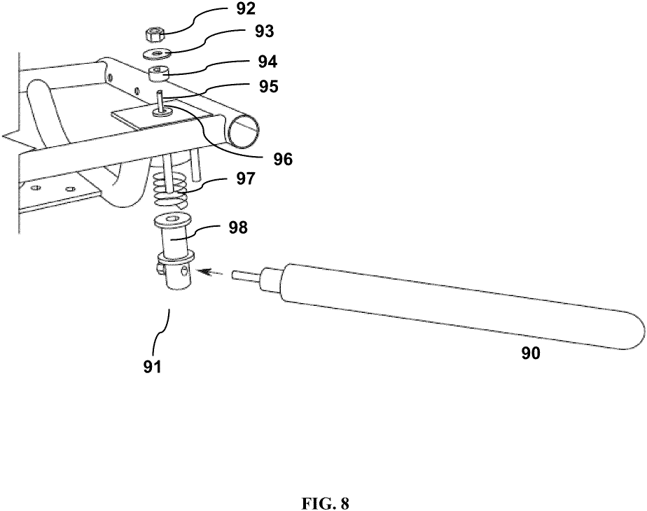

Referring to FIG. 8, in certain embodiments, one end of the braking lever 90 is connected to a hinge mechanism 91 mounted mainly on one side of the bottom frame 80. The braking lever 90 by means of the hinge mechanism 91 is pivotable relative to the bottom frame 80. In certain embodiments, the hinge mechanism 91 comprises a nut 92, a first washer 93, a cam 94, a spindle 95, a second washer 96, a coil spring 97, and a stem 98. Both the stem 98 and the cam 94 are configured to fit onto the spindle 95. This allows the stem 98 and the cam 94 to pivot from the starting position SP to the end position EP along with the braking lever 90 when an external force is applied to the braking lever 90. On the other hand, the coil spring 97 can return the braking lever 90 from the end position EP to the starting position SP when the external force is gone. Biasing members other than the coil spring 97 can equally be used, such as magnets.

In certain embodiments, one or more lever sensor or mechanical switch (not shown) may be used to detect the pivotal movement of the braking lever 90, thereby the first safety mechanism can be actuated as the first threshold is reached. The lever sensor can be an angle sensor that detects the pivoting angle of the braking lever 90. The detected pivoting angle is then compared with the first threshold. Other types of sensor are equally applicable, such as a photodiode sensor, a magnetic sensor or a potentiometer. The mechanical switch can be coupled with the cam 94 of the hinge mechanism 91. The contour of the cam surface corresponds to the pivoting angle of the braking lever 90. The cam 94 can also be replaced with other structures of a similar function. Other ways of coupling the pivoting movement of the braking lever 90 to the sensor or switch are also possible and within the contemplation of the present disclosure.

The placement of the braking lever 90 (i.e. the starting position SP) can be dependent on the spiral direction of the helical auger blade 74. For instance, as seen in FIG. 1, with the helical auger blade 74 screws towards the distal end 73 in a clockwise direction, the braking lever 90 is positioned at the left side of the digging apparatus 1 as viewed from the controller side 13 such that the braking lever 90 can be moved pivotally from the starting position SP to the end position EP during kickback. In certain embodiments, the braking lever 90 is positioned relative to the bottom frame 80 and may be adjustable by the operator in terms of position and orientation relative to the bottom frame 80.

As the earth formation can be unpredictable with soil or sand having diverse physical properties and compositions, when drilling through stones or hard rock, such as granite or limestone, the helical auger blade 74 may not advance downwardly and a kickback may occur, causing an opposite force exerted on the operator. The digging apparatus 1 may dangerously self-rotate in a reverse circulation manner, which is an anticlockwise direction as viewed from the controller side 13. Therefore, the drill bit 12 could possibly rotate abnormally without abutting the ground during the kickback, which may potentially cause injury of the operator at the lower body. Advantageously, the braking lever 90 in the digging apparatus 1 of the present disclosure is installed on the bottom frame 80 such that the braking lever 90 is rotated together with the bottom frame 80. When the bottom frame 80 is rotated in an anticlockwise direction during the kickback, the braking lever 90 is also rotated in an anticlockwise direction and collides with the waist or thigh of the operator. As a result, the braking lever 90 is pushed to the end position EP during the collision, which is detected by the lever sensor 134 or switch and actuates the first safety mechanism. The sensitivity of the lever sensor 134 may also be adjustable. The braking lever 90 will return to the starting position SP under the influence of the hinge 91 without collision.

In certain embodiments, the second safety mechanism is actuated when the powerhead spins at an angular speed over a second threshold. The second threshold can be a fixed one, or adjustable according to different operators. In certain embodiments, the second threshold can be an angular speed between 180 degrees per second and 360 degrees per second, between 200 degrees per second and 350 degrees per second, between 220 degrees per second and 340 degrees per second, between 240 degrees per second and 330 degrees per second, between 260 degrees per second and 320 degrees per second, or between 280 degrees per second and 310 degrees per second. The second safety mechanism can be actuated more than once during the operation of the digging apparatus. In other words, there can be more than one second threshold.

In certain embodiments, the second safety mechanism comprises a rotation sensor mounted to the powerhead 10 or the handle frame 11 to detect the rotation speed of the powerhead 10 or the handle frame 11. The detected rotation speed is compared with the second threshold. In certain embodiments, the rotation sensor is a gyroscopic sensor 132. The gyroscopic sensor 132 may be a single axis, a two-axis, or a three-axis micro-electromechanical systems (MEMS) sensor, or a rotation type sensor. Other types of sensors are equally applicable and within the contemplation of the present disclosure. In certain embodiments, the gyroscopic sensor 132 detects and acceleration speed of the spinning of the powerhead 10 or the handle frame 11.

In other embodiments, if the detected rotation speed is larger than or equals to a first value, the second safety mechanism can be actuated, and a first safety measure can be activated. If the detected rotation speed is larger than or equals to a second value, the second safety mechanism can be actuated again, and a second safety measure can be activated. In certain embodiments, the first safety measure can be reducing power supply to the motor and the second safety measure can be cutting off power supply to the motor. In certain embodiments, the first safety measure can be cutting off power supply to the motor and the second safety measure can be reversing rotation of the motor for a predetermined period of time. Other combinations of first safety measure and second safety measure are also possible. Also, there can be more than two threshold rotation speed.

In certain embodiments, the first safety mechanism and the second safety mechanism can be interlinked. If both the first safety mechanism and the second safety mechanism are actuated, a more aggressive safety measure can be activated. For instance, if only the first safety mechanism or the second safety mechanism is actuated, the power supply to motor may be cut off. If both the first safety and the second safety mechanism are actuated, the motor rotation may be reversed for a predetermined period of time.

In certain embodiments, the gyroscopic sensor or other types of sensor also detect various conditions of the digging apparatus 1. For instance, the gyroscopic sensor can detect at least the degree of tilting of the digging apparatus 1 during operation. The tilting of the drill bit 12 is monitored for maintaining a substantially straight drilling direction, which is perpendicular to the ground. If the tilting of the drill bit exceeds a threshold, the safety mechanism may also be actuated.

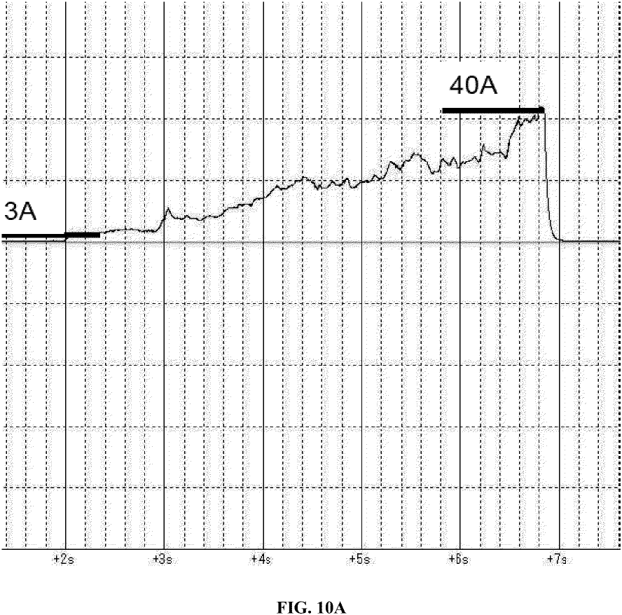

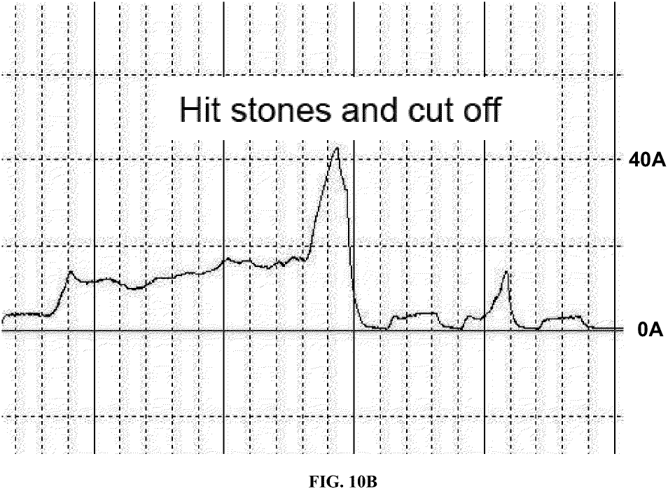

In certain embodiments, a current sensor 131 is provided for measuring at least the electric current delivered from the battery 31 or to the motor 50. The current sensor 131 may be implemented by shunt measurement of the current from the battery 31, which can be realized by using a current detection resistor, an operational amplifier, a current transformer, or other similar electronic devices. The data from the current sensor 131 is coupled to a control module 30. FIG. 10A shows a current profile of the digging apparatus 1 with an increasing electric current from the battery 31. The digging apparatus 1 operates a free run without digging into any substrate with a current of approximately 3.2 A. When the digging apparatus 1 is digging into a substrate with a torque of approximately 120 Nm, the electric current may be higher than 40 A. The current sensor 131 detects current exceeding a third threshold and the motor 50 is stopped and locked. FIG. 10B is a graph showing the electric current measurement when the digging apparatus 1 hits some stones or hard rocks in soil. The electric current may increase significantly in such event with an electric current of more than 40A. The current sensor 131 detects current exceeding the third threshold and the motor 50 is stopped and locked.

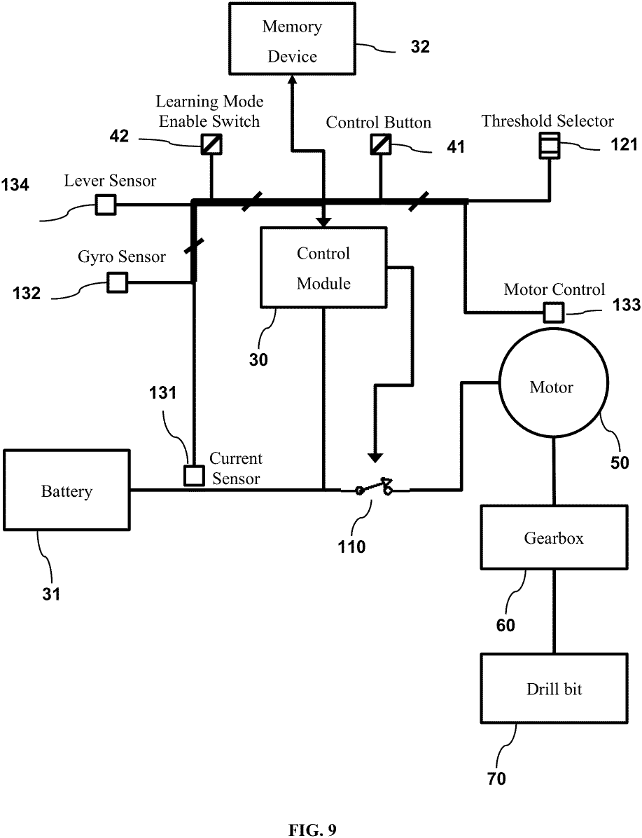

FIG. 9 shows a schematic electrical connection diagram of the digging apparatus 1 in accordance with certain embodiments of the present disclosure. The battery 31 provides electric power to the motor 50 and the control module 30. A switch 110 is provided between the battery 31 and the motor 50 for cutting off electric power supplied from the battery 31 to the motor 50. Alternatively, the switch 110 may be configured to enable or disable the operation of the motor 50 by locking the motor 50 or actuating a clutch. The clutch is configured to remove inertia within the gearbox 60.

In certain embodiments, the first threshold and the second threshold that will actuate the first safety mechanism and the second safety mechanism are configurable by the operator. This configuration allows independent customization of the safety threshold and the sensitivity of the safety mechanism as provided by the braking lever 90 and the lever sensor 134 and the rotation sensor 132.

In certain embodiments, a threshold selector 121 is provided for the operator to select from a plurality of safety thresholds for each of the first safety mechanism and the second safety mechanism. The threshold selector 121 can be provided at the user interface 104. The plurality of safety thresholds set the standards based on which the first safety mechanism and the second safety mechanism can be actuated. For instance, the threshold selector 121 allows a selection between a low threshold, a medium threshold, or a high threshold for each safety mechanism. When a low threshold is selected, the safety mechanism can be actuated more easily, e.g. when the powerhead 11 spins a relatively small angle, or spins at a relatively small angular speed. When a high threshold is selected, the safety mechanism can be actuated less easily, e.g. when the powerhead 11 spins a relatively large angle, or spins at a relatively large angular speed. The plurality of safety thresholds can be set at factory or by an operator.

The control module 30 comprises electronic circuits and components with computing capability to achieve control of the motor and the safety mechanisms. As such, in practical implementations of the control module 30, the control module 30 includes one or more processors and memory device 32. When any one of the sensors discussed above detects a signal exceeding the safety threshold, the control module 30 is configured to generate an emergency stop/control instruction to stop or reduce power supply to the motor 50. Alternatively, with the emergency stop/control instruction, the motor 50 can be controlled otherwise as discussed above.

In certain embodiments, the control module 30 is configured with a learning mode. The learning mode is provided to assist the operator to determine an appropriate safety standard suitable to his or her personal physical conditions. In real world applications, it can be inefficient or even dangerous to use the same safety standard for all operators, without taking into account the operator’s physical strength. The control module 30, comprising one or more processors and memory device 32, is configured to allow the operator to generate and configure user-specific operation profile. The user-specific operation profile records user-specific safety thresholds.

To configure the user-specific operation profile, the control module 30 enters the learning mode and the motor output torque increases gradually or stepwise from zero. The operator starts the drilling using the digging apparatus and the control module 30 keeps tracking various parameters, such as motor current, motor output torque, powerhead spinning angle, powerhead spinning angular speed. The motor output torque increases continuously in the process until interrupted by a specified event. Upon interruption, at least one of the motor current, motor output torque, powerhead spinning angle, powerhead spinning angular speed or other parameters is recorded and converted to the safety threshold for the first safety mechanism and/or the second safety mechanism.

The specified event can be various. In certain embodiments, the specified event is the operator releasing the control button 41 or pressing a trigger. Alternatively, the specified event is the powerhead spins for a predetermined angle, or spins above a predetermined angular speed or a predetermined angular acceleration speed. In other embodiments, the specified event could be the operator hitting braking lever 90. The user-specific profile for each operator is then memorized and stored in the memory device 32.

This illustrates the fundamental structure and mechanism of the digging apparatus in accordance with the present disclosure. The digging apparatus is designed in accordance with a hand-operated ground auger, and it is apparent that the present disclosure may be embodied in other types of digging tools without departing from the spirit or essential characteristics thereof. The present embodiment is, therefore, to be considered in all respects as illustrative and not restrictive. The scope of the disclosure is indicated by the appended claims rather than by the preceding description, and all changes that come within the meaning and range of equivalency of the claims are therefore intended to be embraced therein.

What is claimed is:

1. An electric powered digging apparatus, comprising:
a powerhead, the power head comprises a motor and a gearbox;
a handle frame, the powerhead is mounted onto the handle frame; and
a drill bit, the drill bit is driven by the motor to rotate around a longitudinal axis,
the electric power digging apparatus further comprises:
a first safety mechanism, wherein the first safety mechanism reduces torque output to the drill bit when the powerhead spins around the longitudinal axis for an angle larger than a first threshold, and
a second safety mechanism, wherein the second safety mechanism reduces torque output to the drill bit when the powerhead spins around the longitudinal drive axis at an angular speed larger than a second threshold.

2. The electric powered digging apparatus of claim 1, wherein the first safety mechanism comprises a braking lever extending out from the handle frame, the braking level is pivotable relative to the handle frame from a starting position to an end position, an angle between the starting position and the end position of the braking lever is larger than or equal to the first threshold.

3. The electric powered digging apparatus of claim 2, wherein the end position comprises a first end position corresponding to a first value of the first threshold, and a second end position corresponding to a second value of the first threshold.

4. The electric powered digging apparatus of claim 2, wherein the first safety mechanism further comprises a sensor for sensing the pivoting angle of the braking lever.

5. The electric powered digging apparatus of claim 2, wherein the first safety mechanism further comprises a switch to be actuated by the braking lever as it pivots from the starting position to the end position.

6. The electric powered digging apparatus of claim 2, wherein the first safety mechanism further comprises a biasing member for returning the braking lever from the end position to the starting position.

7. The electric powered digging apparatus of claim 2, wherein the starting position of the braking lever is adjustable.

8. The electric powered digging apparatus of claim 1, wherein the second safety mechanism comprises a rotation sensor coupled to the power head or the handle frame, the rotation sensor is configured to measure the angular speed of the power head or the handle frame.

9. The electric powered digging apparatus of claim 8, wherein the rotation sensor is a gyroscopic sensor.

10. The electric powered digging apparatus of claim 1, wherein the electric power to the motor is cut off when at least one of the first safety mechanism and the second safety mechanism is actuated.

11. The electric powered digging apparatus of claim 1, wherein the electric power to the motor is reduced so that the motor output toque is reduced when at least one of the first safety mechanism and the second safety mechanism is actuated.

12. The electric powered digging apparatus of claim 1, wherein the motor rotation is reversed for a predetermined period of time when at least one of the first safety mechanism and the second safety mechanism is actuated.

13. The electric powered digging apparatus of claim 1, wherein the powerhead further comprises a clutch, the clutch is actuated to lock the motor and/or gearbox when at least one of the first safety mechanism and the second safety mechanism is actuated.

14. The electric powered digging apparatus of claim 1, further comprising a current sensor, electric power to the motor is cut off when the current sensor measures an electric current to the motor larger than a third threshold.

15. The electric powered digging apparatus of claim 1, further comprising a control module, the control module is configured to input, store and apply user-specific operation profile, wherein each user-specific operation profile allows a respective user to specify at least one of the first threshold and the second threshold.

16. The electric powered digging apparatus of claim 14, wherein the control module is configured for the user to input a respective operation profile with a learning mode, at least one of the first threshold and the second threshold is determined when a specified event occurs as a motor output torque is increased from zero.

17. The electric powered digging apparatus of claim 14, wherein the specified event is selected from one of the following: a user releases a trigger, a user presses a trigger, the powerhead spins for a predetermined angle, the powerhead spins above a predetermined angular speed, and the powerhead spins above a predetermined angular acceleration speed.

18. The electric powered digging apparatus of claim 1, further comprising a threshold selector for an operator to select from multiple values for the first threshold and/or the second threshold.
